(19) United States
(12) Patent Application Publication
(10) Pub. No.: US 2015/0378534 A1
(43) Pub. Date: Dec. 31, 2015

(54) METHOD AND SYSTEM FOR CONTINUOUS READING MODE

(71) Applicant: Kobo Inc., Toronto (CA)

(72) Inventor: Dae Hyuk Yoon, Toronto (CA)

(21) Appl. No.: 14/318,166

(22) Filed: Jun. 27, 2014

(51) Int. Cl. G06F 3/0483; G06F 3/0484; G06F 3/0485

(52) U.S. Cl. CPC G06F 3/0483; G06F 3/0485; G06F 3/04842

(57) ABSTRACT

A computing device includes a housing and a display assembly having a screen and a set of touch sensors. The housing at least partially circumvents the screen so that the screen is viewable. A processor is provided within the housing to display content pertaining to an e-book on the screen of the display assembly. The processor further detects a first user interaction with the set of touch sensors and interprets the first user interaction as a first user input. In response to the first user input, the processor scrolls the e-book content displayed on the screen. For example, the first user input may correspond with a user tapping and holding the screen of the display assembly.

### TECHNICAL FIELD

Examples described herein relate to a computing device that continuously scrolls content across a display in response to a user input.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing e-book services on a computing device, according to an embodiment.

FIG. 2 illustrates an example of an e-reader device or other electronic personal display device, for use with one or more embodiments described herein.

FIGS. 3A-3B illustrate embodiments of an e-reader device that responds to user input by scrolling content across a display screen.

FIG. 4 illustrates an e-reader system for displaying e-book content, according to one or more embodiments.

FIG. 5 illustrates a method of continuously scrolling e-book content, according to one or more embodiments.

FIGS. 6A-6B illustrate an exemplary e-reader display that scrolls content in response to a user input while emphasizing a portion of the content as it scrolls across the display, according to one or more embodiments.

### DETAILED DESCRIPTION

Embodiments described herein provide for a computing device that responds to a particular type of user input by scrolling content provided on a display screen. In some embodiments, the user input may correspond with a user tapping and holding a region of the display screen. Still further, in some embodiments, a portion of the display screen may be emphasized while scrolling the content.

According to some embodiments, a computing device includes a housing and a display assembly having a screen and a set of touch sensors. The housing at least partially circumvents the screen so that the screen is viewable. A processor is provided within the housing to display content pertaining to an e-book on the screen of the display assembly. The processor further detects a first user interaction with the set of touch sensors and interprets the first user interaction as a first user input. In response to the first user input, the processor scrolls the e-book content displayed on the screen.

For some embodiments, the first user input may correspond with a user tapping and holding the screen of the display assembly. Further, the processor may scroll the e-book content by continuously updating the content displayed on the screen until the user releases contact with the screen. More specifically, the processor may scroll the e-book content in a particular direction based on a region of the screen on which the first user input is received. For example, the processor may scroll the e-book content in an upward direction when the first user input is received at a lower region of the screen. Alternatively, and/or additionally, the processor may scroll the e-book content in a downward direction when the first user input is received at an upper region of the screen.

Still further, for some embodiments, the processor may emphasize a portion of the screen while scrolling the e-book content in response to the first user input. For example, the emphasized portion of the screen may coincide with a centerline (e.g., midsection) of the screen. More specifically, the emphasized portion of the screen may coincide with one or more lines of text associated with the e-book content. In some embodiments, the processor may emphasize a particular portion of the screen by obfuscating (e.g., darkening, blacking out, and/or redacting) content displayed on the remainder of the screen.

Among other benefits, examples described herein provide an enhanced reading experience to users of e-reader devices (or similar computing devices). Scrolling e-book content in response to tap-and-hold inputs facilitates single-handed operation of e-reader devices. For example, a user may hold the device in one hand while manipulating the displayed e-book content by simply holding down (and/or lifting off) one of the user's fingers (e.g., the user's thumb). Furthermore, the continuous scrolling feature enables the user to read through e-books at a steady or relatively constant pace (e.g., without having to refocus or realign the user's eyes on the display screen).

One or more embodiments described herein provide that methods, techniques and actions performed by a computing device are performed programmatically, or as a computer-implemented method. Programmatically means through the use of code, or computer-executable instructions. A programmatically performed step may or may not be automatic. As used herein, the terms “scroll” or “scrolling” refer to a particular method of updating the content and/or state of a display such that the content is perceived to be moving (e.g., upward or downward) across the display. Moreover, the term “obfuscating” may refer to any method of rendering content illegible or difficult to view.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

### System Description

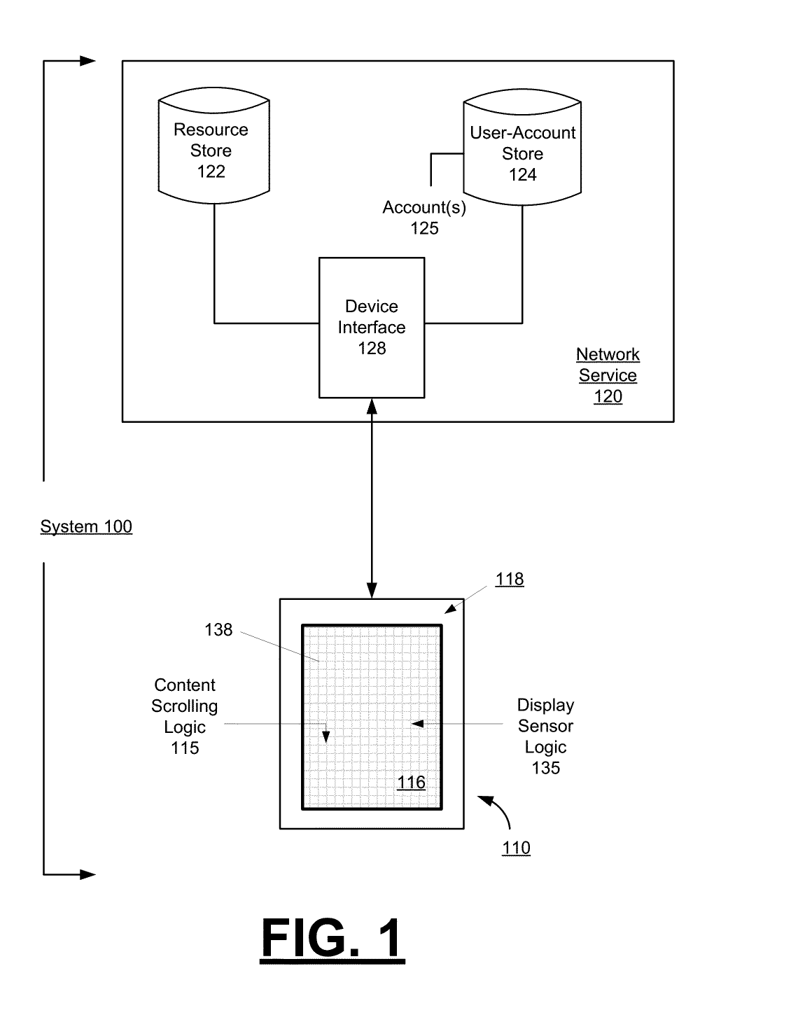

FIG. 1 illustrates a system 100 for utilizing applications and providing e-book services on a computing device, according to an embodiment. In an example of FIG. 1, system 100 includes an electronic display device, shown by way of example as an e-reader device 110, and a network service 120. The network service 120 can include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application that receives files or streaming data from the network service 120. By way of example, the e-reader device 110 can be equipped with hardware and software to optimize certain application activities, such as reading electronic content (e.g., e-books). For example, the e-reader device 110 can have a tablet-like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

With reference to an example of FIG. 1, e-reader device 110 can include a display screen 116 and a housing 118. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing 118 can also be integrated with touch sensors to provide one or more touch sensing regions, for example, on the bezel and/or back surface of the housing 118.

According to some embodiments, the e-reader device 110 includes display sensor logic 135 to detect and interpret user input made through interaction with the touch sensors 138. By way of example, the display sensor logic 135 can detect a user making contact with the touch sensing region of the display 116. For some embodiments, the display sensor logic 135 may interpret a touching and holding of (e.g., continuous contact with) one or more touch sensors 138 as a particular type of user input. For example, the user may tap and hold the touch sensing region of the display 116 to trigger a change in state of the device 110 and/or the display 116. More specifically, the duration of the hold (e.g., contact with the touch sensing region) may correlate with a magnitude and/or duration of the user input.

In some embodiments, the e-reader device 110 includes features for providing functionality related to displaying e-book content. For example, the e-reader device can include content scrolling logic 115, which enables the user to scroll through the e-book content. Rather than transition through e-book content in a paginated manner (e.g., by displaying one page of e-book content followed by another), the content scrolling logic 115 may scroll the e-book content across the display 116, for example, by continuously updating the content of the display 116. With each update, the content scrolling logic 115 may transition in (and transition out) one or more lines of e-book content on the display 116 (e.g., disregarding page breaks, numbering, and/or formatting). This allows the user to read through an e-book while keeping the user's eyes trained or focused on a particular region of the display 116.

The content scrolling logic 115 can be responsive to various kinds of interfaces and actions in order to enable scrolling of e-book content. In one implementation, a user can cause the e-book content to scroll across the display 116 by, for example, interacting with the touch sensing region of the display 116. For example, the user can trigger a page scrolling action by tapping and holding the surface of the display 116. Alternatively, and/or additionally, the user may trigger a page scrolling action by tapping and holding a touch sensing region of the housing 118.

### Hardware Description

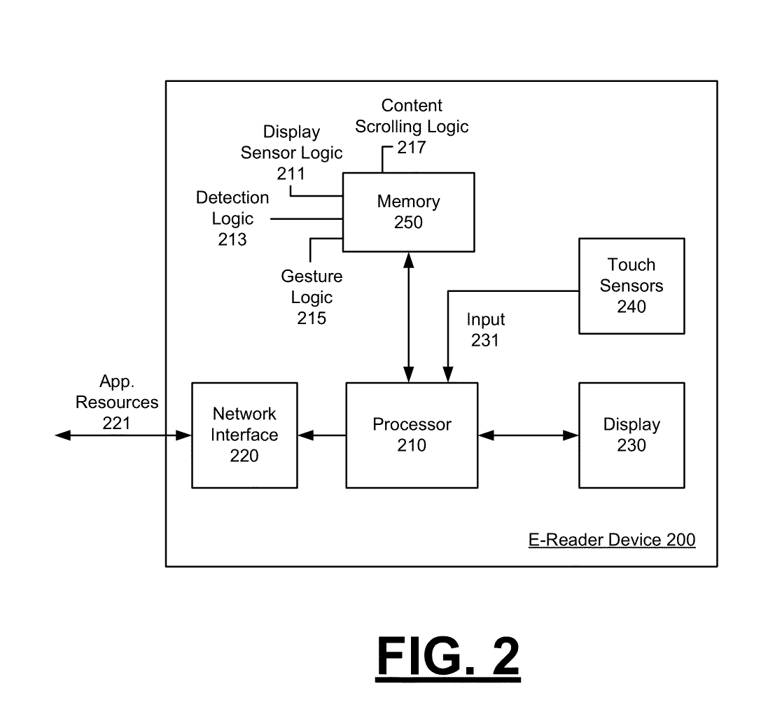

FIG. 2 illustrates an example of an e-reader device 200 or other electronic personal display device, for use with one or more embodiments described herein. In an example of FIG. 2, an e-reader device 200 can correspond to, for example, the device 110 as described above with respect to FIG. 1. With reference to FIG. 2, e-reader device 200 includes a processor 210, a network interface 220, a display 230, one or more touch sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources 221, such as e-books or media files, that the user elects to purchase or otherwise download from the network service 120. The application resources 221 that are downloaded onto the e-reader device 200 can be stored in the memory 250.

In some implementations, the display 230 can correspond to, for example, a liquid crystal display (LCD), an electrophoretic display (EPD), or a light emitting diode (LED) display that illuminates in order to provide content generated from processor 210. In some implementations, the display 230 can be touch-sensitive. For example, in some embodiments, one or more of the touch sensor components 240 may be integrated with the display 230. In other embodiments, the touch sensor components 240 may be provided (e.g., as a layer) above or below the display 230 such that individual touch sensor components 240 track different regions of the display 230. Further, in some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 240, the display 230, and/or other input mechanisms (e.g., buttons, keyboard, mouse, microphone, etc.). With reference to examples described herein, the processor 210 can respond to input 231 from the touch sensor components 240. In some embodiments, the processor 210 responds to inputs 231 from the touch sensor components 240 in order to facilitate or enhance e-book activities such as powering off the device 200 and/or display 230, activating a screen saver, launching an application, and/or otherwise altering a state of the display 230.

In some embodiments, the memory 250 may store display sensor logic 211 that monitors for user interactions detected through the touch sensor components 240 provided with the display 230, and further processes the user interactions as a particular input or type of input. In an alternative embodiment, the display sensor logic 211 may be integrated with the touch sensor components 240. For example, the touch sensor components 240 can be provided as a modular component that includes integrated circuits or other hardware logic, and such resources can provide some or all of the display sensor logic 211 (see also display sensor logic 135 of FIG. 1). For example, integrated circuits of the touch sensor components 240 can monitor for touch input and/or process the touch input as being of a particular kind. In variations, some or all of the display sensor logic 211 may be implemented with the processor 210 (which utilizes instructions stored in the memory 250), or with an alternative processing resource.

In one implementation, the display sensor logic 211 includes detection logic 213 and gesture logic 215. The detection logic 213 implements operations to monitor for the user contacting a surface of the display 230 coinciding with a placement of one or more touch sensor components 240. The gesture logic 215 detects and correlates a particular gesture (e.g., pinching, swiping, tapping, etc.) as a particular type of input or user action. In some embodiments, the gesture logic 215 may detect when a user taps and holds the surface of the display 230 and associate the tap-and-hold gesture with a particular type of input based, in part, on the duration of the hold. The gesture logic 215 can also detect directionality so as to distinguish between, for example, leftward or rightward swipes.

The memory 250 further stores content scrolling logic 217 to scroll content across the display 230 in response to certain types of user input. For example, the content scrolling logic 217 may interpret a tap-and-hold input as a content scrolling request. More specifically, the content scrolling logic 217 may begin scrolling content across the display 230 only after a user taps and holds the touch sensing region of the display 230 for a threshold duration. The content scrolling logic 217 may continuously scroll and/or update the content on the display 230 for the duration of the tap-and-hold input (e.g., until the user releases contact with the touch sensing region of the display 230). For some embodiments, the user may toggle an auto-scrolling feature, for example, by tapping and/or double-tapping the touch sensing region of the display 230. For example, in response to a double-tap input, the content scrolling logic 217 may continuously scroll the content on the display even after the user's finger is no longer in contact with the display 230. Furthermore, the user may terminate auto-scrolling, for example, with a subsequent tap (e.g., single-tap) of the touch sensing region of the display 230.

In some embodiments, the content scrolling logic 217 may determine a directionality of the content scrolling request based on a region of the display 230 on which the input is received. For example, the content scrolling logic 217 may scroll the content in an upward direction if the user taps and holds a lower region of the display 230. On the other hand, the content scrolling logic 217 may scroll the content in a downward direction if the user taps and holds an upper region of the display 230.

### Continuous Content Scrolling

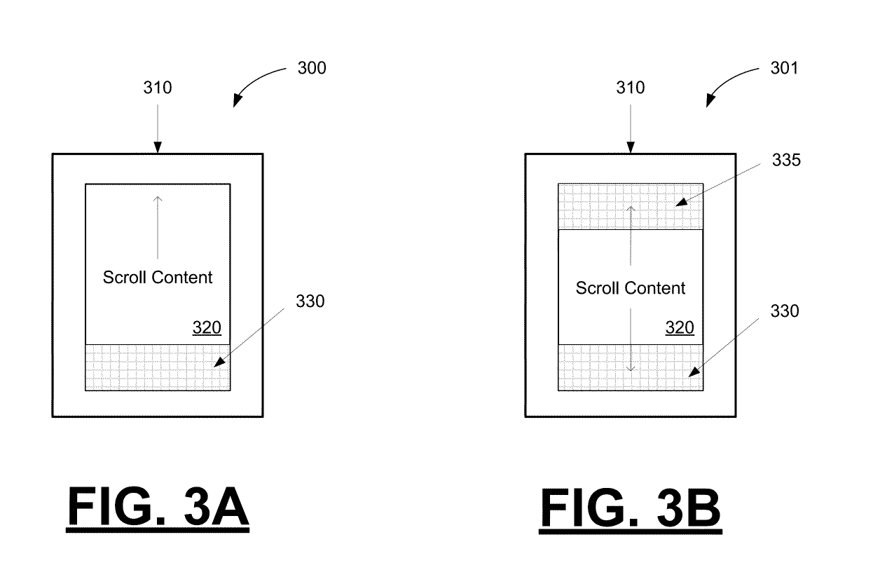

FIGS. 3A-3B illustrate embodiments of an e-reader device that responds to user input by scrolling content across a display screen. With reference to FIG. 3A, the e-reader device 300 includes a housing 310 and a display screen 320. The e-reader device 300 can be substantially tabular or rectangular, so as to have a front surface that is substantially occupied by the display screen 320 so as to enhance content viewing. More specifically, the front surface of the housing 310 may be in the shape of a bezel surrounding the display screen 320. The display screen 320 can be part of a display assembly, and can be touch sensitive. For example, the display screen 320 can be provided as a component of a modular display assembly that is touch-sensitive and integrated with housing 310 during a manufacturing and assembly process.

A touch sensing region 330 is provided with at least a portion of the display screen 320. Specifically, the touch sensing region 330 may coincide with the integration of touch sensors with the display screen 320. In a particular example, as shown in FIG. 3A, the touch sensing region 330 is provided with a bottom portion of the display screen 320. For other embodiments, the touch sensing region 330 may substantially encompass a surface of the display screen 320. Further, the e-reader device 300 can integrate one or more types of touch-sensitive technologies in order to provide touch sensitivity on the touch sensing region 330 of the display screen 320. It should be appreciated that a variety of well-known touch sensing technologies may be utilized to provide touch-sensitivity, including, for example, resistive touch sensors, capacitive touch sensors (using self and/or mutual capacitance), inductive touch sensors, and/or infrared touch sensors.

For example, the touch-sensing feature of the display screen 320 can be employed using resistive sensors, which can respond to pressure applied to the surface of the display screen 320. In a variation, the touch-sensing feature can be implemented using a grid pattern of electrical elements which can detect capacitance inherent in human skin. Alternatively, the touch-sensing feature can be implemented using a grid pattern of electrical elements which are placed over or just beneath the surface of the display screen 320, and which deform sufficiently on contact to detect touch from an object such as a finger.

The e-reader device 300 may further include a backlight 330 to provide illumination for the display 320. The backlight 330 may be comprised of one or more light-emitting diodes (LEDs), an electroluminescent panel (ELP), one or more fluorescent lamps, and/or one or more incandescent light bulbs. For example, one or more components of the backlight 330 may be provided under the display 320, to illuminate the display 320 from behind. Alternatively, and/or in addition, one or more components of the backlight 330 may be provided within the bezel of the housing 310, to provide side illumination to the display 320 (e.g., from one or more edges of the display). Still further, in some implementations, the e-reader device 300 may be illuminated from the front.

For some embodiments, the e-reader device 300 may respond to user input received via the touch sensing region 330 by scrolling content across the display screen 320. More specifically, the e-reader device 300 may interpret a tap-and-hold gesture performed on a surface of the display 320 coinciding with the touch sensing region 330 as a content scrolling request. In response to the content scrolling request, the device 300 may begin scrolling content across the display screen 320. For example, the e-reader device 300 may scroll e-book content in an upward direction to advance through (e.g., towards the end of) the e-book. The e-reader device 300 may scroll the e-book content by continuously updating the content on the display screen 320 one or more lines at a time. For example, older content (e.g., along the top of the display screen 320) may be scrolled off the display screen 320 as newer content is scrolled in (e.g., from the bottom of the display screen 320).

For some embodiments, the scroll speed may be user-configurable. For example, the scroll speed may be programmed based on a preferred reading speed and/or a speed that is comfortable to the user of the e-reader device 300. In some embodiments, the user may activate a speed control menu, for example, by tapping the center of the display 320. If auto-scrolling has been enabled in the background, the user may view the changes in scroll speeds as the content is updated in real-time. This may assist the user with selecting a scroll speed that the user is most comfortable with.

It should be noted that, in embodiments where the touch sensing region 330 substantially encompasses the surface of the display screen 320, activation of the content scrolling feature may depend on the location of the tap-and-hold input. For example, the e-reader device 300 may begin scrolling content only if the user taps and holds the lower region of the display screen 320 (e.g., coinciding with the touch sensing region 300 shown in FIG. 3A).

FIG. 3B shows an embodiment of an e-reader device 301 that can scroll content in two directions (e.g., upward and downward). Specifically, the e-reader device 301 includes an upper touch sensing region 335 and a lower touch sensing region 330. As described above, with reference to FIG. 3A, the e-reader device 301 may respond to user input received via the lower touch sensing region 330 by scrolling e-book content in an upward direction (e.g., to advance towards the end of the e-book). For some embodiments, the e-reader device 301 may further respond to user input received via the upper touch sensing region 335 by scrolling the e-book content in a downward direction (e.g., to back-step towards the beginning of the e-book). For example, more recent content (e.g., along the bottom of the display screen 320) may be scrolled off the display screen 320 as older content is scrolled in (e.g., from the top of the display screen 320). This enables the user to have full control over the content that is displayed on the display screen 320.

### Content Scrolling Functionality

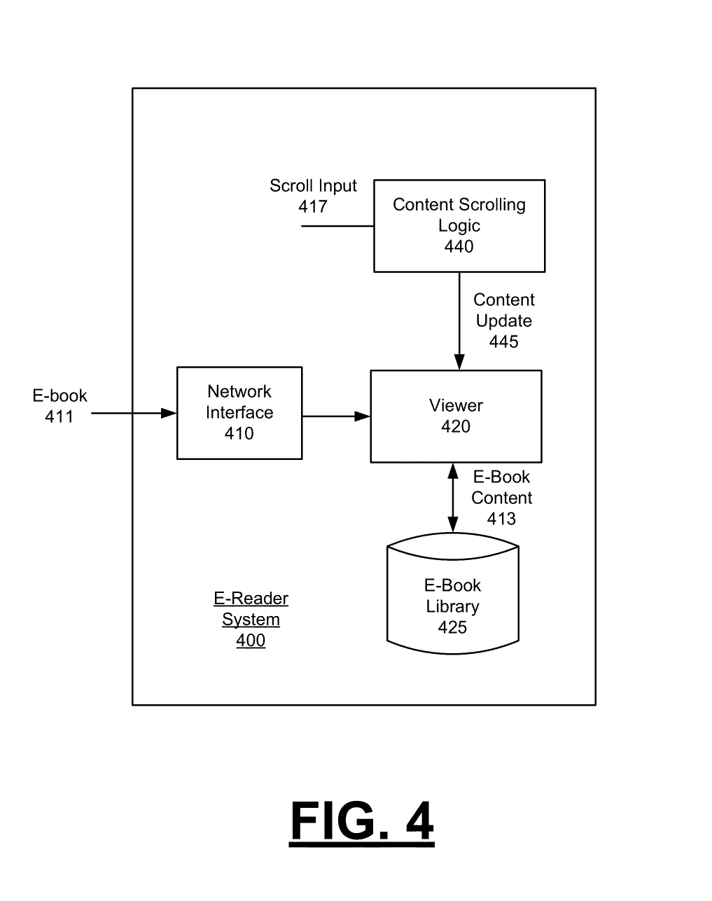

FIG. 4 illustrates an e-reader system 400 for displaying e-book content, according to one or more embodiments. An e-reader system 400 can be implemented as, for example, an application or device, using components that execute on, for example, an e-reader device such as shown with examples of FIGS. 1, 2 and 3A-3B. Furthermore, an e-reader system 400 such as described can be implemented in a context such as shown by FIG. 1, and configured as described by an example of FIG. 2 and FIGS. 3A-3B.

In an example of FIG. 4, a system 400 includes a network interface 410, a viewer 420 and content scrolling logic 440. As described with an example of FIG. 1, the network interface 410 can correspond to a programmatic component that communicates with a network service in order to receive data and programmatic resources. For example, the network interface 410 can receive an e-book 411 from the network service that the user purchases and/or downloads. E-books 411 can be stored as part of an e-book library 425 with memory resources of an e-reader device (e.g., see memory 250 of e-reader device 200).

The viewer 420 can access e-book content 413 from a selected e-book, provided with the e-book library 425. The e-book content 413 can correspond to one or more pages that comprise the selected e-book. Additionally, the e-book content 413 may correspond to portions of one or more pages of the selected e-book. The viewer 420 renders the one or more pages on a display screen at a given instance, corresponding to the retrieved e-book content 413. The display state rendered by the viewer 420 can correspond to a particular page, set of pages, or portions of one or more pages of the selected e-book that are displayed at a given moment.

The content scrolling logic 440 can be provided as a feature or functionality of the viewer 420. Alternatively, the content scrolling logic 440 can be provided as a plug-in or as independent functionality from the viewer 420. The content scrolling logic 440 can provide content updates 445 to the viewer 420. The content updates 445 can specify a display-state transition, causing the viewer 420 to render new content on the display screen. The content update 445 may specify one or more lines of text to be retrieved, in sequential order, for a selected e-book. For example, given a current display state, each content update 445 may specify a subsequent or a previous line of e-book text and/or content in the sequence.

According to some embodiments, the content scrolling logic 440 can be responsive to different kinds of input, including an input action which signifies a content scrolling request (e.g., scroll input 417). The scroll input 417 can include, for example, an upward scrolling of content and/or a downward scrolling of content. The type of scroll input 417 can be determined from the type of input provided. For example, the scroll input 417 can be provided by the user interacting with the one or more touch sensors provided on a surface of the display screen of the e-reader system 400. Specifically, tap-and-hold gestures detected at a lower region of the display screen may correspond with a scroll input 417 associated with an upward direction. On the other hand, tap-and-hold gestures detected at an upper region of the display screen may correspond with a scroll input 417 associated with a downward direction.

In response to receiving a scroll input 417, the content scrolling logic 440 signals the content update 445 to the viewer 420. The viewer 420 updates the e-book content 413 to reflect the change represented by the content update 445 (e.g., scroll content up or scroll content down). For some embodiments, the content scrolling logic 440 may continuously provide content updates 445 (e.g., at a desired rate) for the duration of the scroll input 417 (e.g., for as long as the user holds the touch sensing region of the display screen).

### Methodology

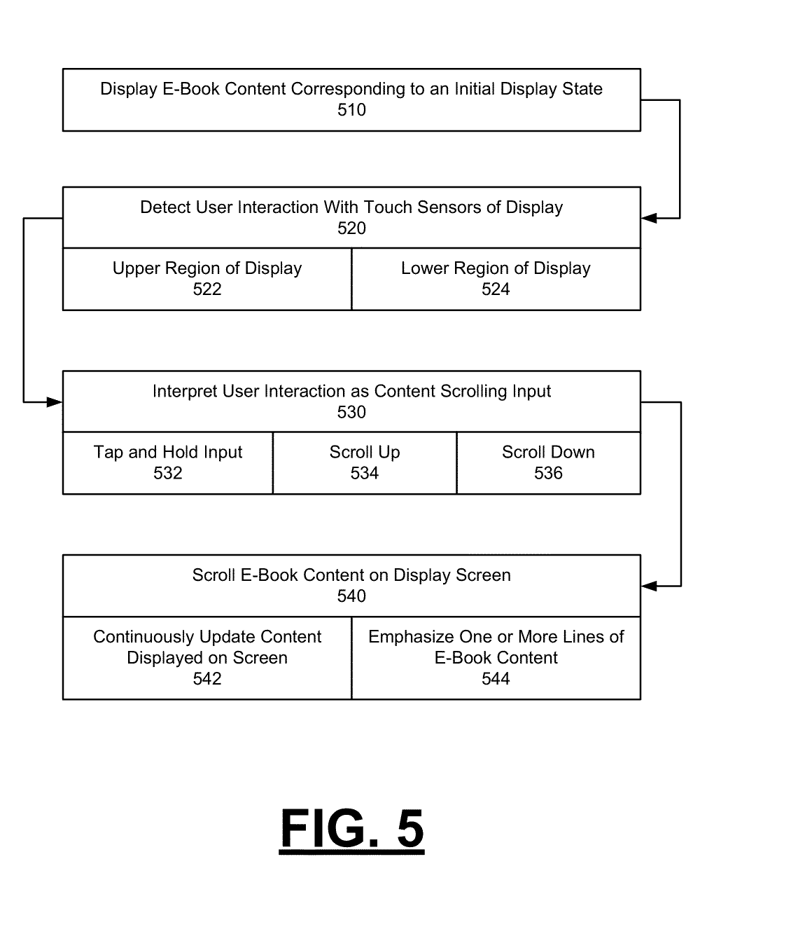

FIG. 5 illustrates a method of continuously scrolling e-book content, according to one or more embodiments. In describing an example of FIG. 5, reference may be made to components such as described with FIGS. 2 and 3A-3B for purposes of illustrating suitable components for performing a step or sub-step being described.

With reference to an example of FIG. 2, the e-reader device 200 may first display e-book content corresponding to an initial display state (510). For example, the device 200 may display a single page (or portions of multiple pages) of an e-book corresponding to the content being read by the user. Alternatively, the device 200 may display multiple pages side-by-side to reflect a display mode preference of the user.

The e-reader device 200 may then detect a user interaction with one or more touch sensors provided (or otherwise associated) with the display 230 (520). For example, the processor 210 can receive inputs 231 from the touch sensor components 240. More specifically, the processor 210, in executing the display sensor logic 211, may monitor for touch-based inputs at an upper region of a surface of the display 230 (522) and/or at a lower region of the surface of the display 230 (525). For example, the processor 210 may interpret the user interactions with the one or more touch sensors to distinguish between various types of input.

The e-reader device 200 may interpret the user interaction as a content scrolling input (530). For example, the processor 210, in executing the content scrolling logic 217, may analyze the duration of a tap-and-hold gesture performed on the one or more touch sensor components 240 to determine whether gesture corresponds with a page scrolling input (532). For example, a page scrolling input may be detected if the hold duration exceeds a threshold duration. The content scrolling logic 217 may further analyze the region of the display 230 that coincides with the tap-and-hold gesture to determine wither the input corresponds with a upward scroll direction (534) or a downward scroll direction (536). For example, a tap-and-hold gesture performed on a lower region of the display 230 may correspond with an upward scrolling direction, whereas a tap-and-hold gesture performed on an upper region of the display 230 may correspond with a downward scrolling direction.

Finally, the e-reader device 200 may scroll the e-book content on the display screen 230 in response to the content scrolling input (540). For example, the e-reader device 200 may scroll the e-book content up or down depending on the directionality of the content scrolling input. More specifically, the e-reader device 200 may scroll e-book content by continuously updating the content displayed on the display screen 230 (540). For example, the e-reader device 200 may update one or more lines of e-book content at a time so that the content appears to “move” across the screen in an upward or downward direction. For some embodiments, the e-reader device 200 may further emphasize one or more lines of e-book content while performing the scrolling function (544). As described in greater detail below, the emphasis may be created by obfuscating content displayed on one or more portions of the display screen 230.

### Visual Focus

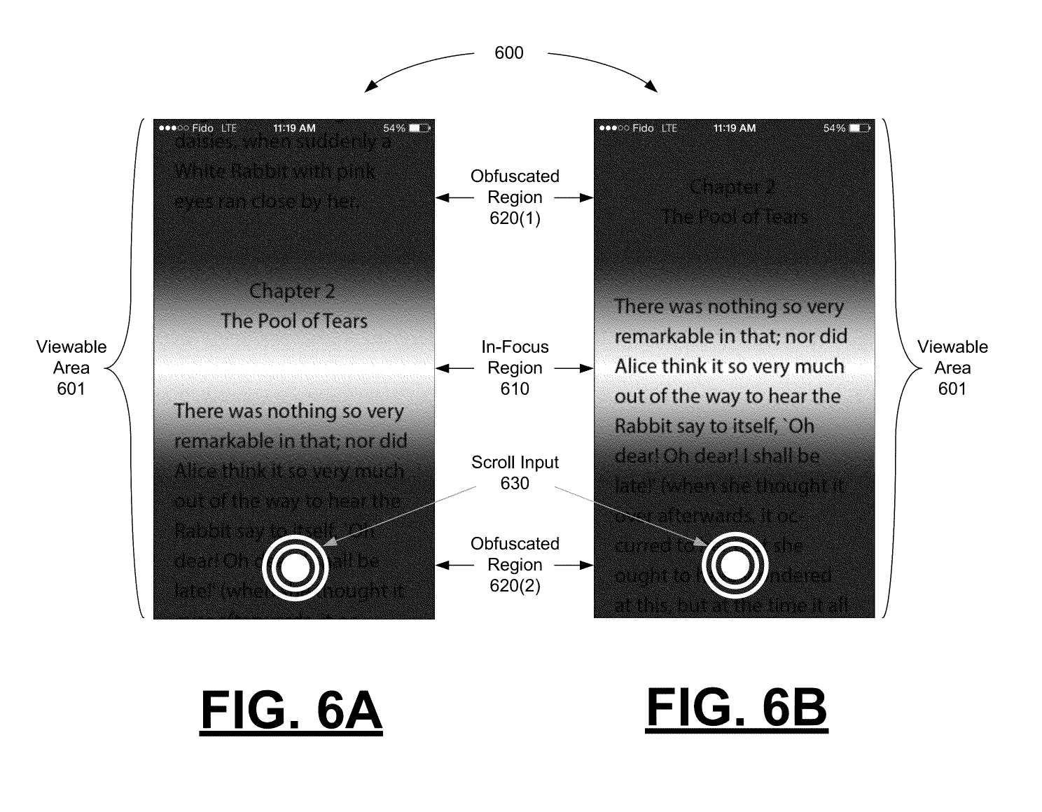

FIGS. 6A-6B illustrate an exemplary e-reader display 600 that scrolls content in response to a user input while emphasizing a portion of the content as it scrolls across the display, according to one or more embodiments. The e-reader display 600 may correspond to the display screen of an e-reader device such as described above with respect to FIGS. 1-4. The e-reader display 600 has a viewable area 601 that substantially encompasses the surface of the display 600. For some embodiments, the e-reader display 600 may include a touch sensing region that covers at least the lower portion of the viewable area 601. Alternatively, and/or additionally, the e-reader display 600 may include a touch sensing region that covers the upper portion of the viewable area 601. Still further, for some embodiments, the touch sensing region may substantially cover the entire viewable area 601.

As shown in FIG. 6A, a scroll input 630 (e.g., corresponding to a tap-and-hold gesture) may be received at a lower region of the display 600 to trigger a continuous scrolling operation (e.g., as described above with respect to FIGS. 1-5). In response to the scroll input 630, the e-reader display 600 may scroll e-book content across the viewable area 601 (e.g., in an upward direction). In addition, the e-reader display 600 may emphasize a portion of the viewable area 601 while the e-book content is being scrolled. For example, the emphasis may be created by providing an in-focus region 610 and one or more obfuscated regions 620(1) and/or 620(2). More specifically, the in-focus region 610 represents the emphasized portion of the e-reader display 600, which may coincide with one or more lines of text content from the selected e-book (e.g., along a horizontal centerline of the e-reader display 600). The remainder of the viewable area 601 is obfuscated (e.g., rendered darker, redacted, or blacked out) to help focus the user's attention towards the in-focus region 610.

Emphasizing only a portion of the viewable area 601 may aid and/or guide the user's reading of e-book content as the content is scrolled across the display 600. For example, the user may be naturally inclined to scan the viewable area 601 in a top-to-bottom manner (e.g., as if reading a printed book). However, this may not be conducive to reading scrolling text. Thus, by emphasizing the in-focus region 610, the e-reader display 600 can help the user to focus on a fixed region of the viewable area 601 so that the user is able to view every line of e-book content as it scrolls across the display 600. In addition, the visual focus feature may indicate to the user that the e-reader display 600 is in a continuous scrolling mode.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a display assembly including a screen;
a housing that at least partially circumvents the screen so that the screen is viewable;
a set of touch sensors provided with the display assembly; and
a processor provided within the housing, the processor operating to:
display content pertaining to an e-book on the screen of the display assembly;
detect a first user interaction with the set of touch sensors;
interpret the first user interaction as a first user input; and
scroll the e-book content displayed on the screen in response to the first user input.

2. The computing device of claim 1, wherein the first user input corresponds with a user tapping and holding the screen of the display assembly.

3. The computing device of claim 2, wherein the processor is to scroll the e-book content by continuously updating the content displayed on the screen until the user releases contact with the screen.

4. The computing device of claim 1, wherein the processor is to scroll the e-book content in a particular direction based on a region of the screen on which the first user input is received.

5. The computing device of claim 4, wherein the processor is to scroll the e-book content in an upward direction when the first user input is received at a lower region of the screen.

6. The computing device of claim 4, wherein the processor is to scroll the e-book content in a downward direction when the first user input is received at an upper region of the screen.

7. The computing device of claim 1, wherein the processor is to further:
emphasize a first portion of the screen while scrolling the e-book content in response to the first user input.

8. The computing device of claim 7, wherein the first portion of the screen coincides with one or more lines of text associated with the e-book content.

9. The computing device of claim 7, wherein the processor is to emphasize the first portion of the screen by obfuscating content displayed on the remainder of the screen.

10. The computing device of claim 7, wherein the first portion of the screen coincides with a centerline of the screen.

11. A method for operating a computing device, the method being implemented by one or more processors and comprising:
displaying content pertaining to an e-book on a screen of a display assembly of the computing device;
detecting a first user interaction with a set of touch sensors provided with the display assembly; and
interpreting the first user interaction as a first user input; and
scrolling the e-book content displayed on the screen in response to the first user input.

12. The method of claim 11, wherein the first user input corresponds with a user tapping and holding the screen of the display assembly.

13. The method of claim 12, wherein scrolling the e-book content comprises:
continuously updating the content displayed on the screen until the user releases contact with the screen.

14. The method of claim 11, wherein scrolling the e-book content comprises:
scrolling the e-book content in a particular direction based on a region of the screen on which the first user input is received.

15. The method of claim 14, wherein scrolling the e-book content comprises:
scrolling the e-book content in an upward direction when the first user input is received at a lower region of the screen.

16. The method of claim 14, wherein scrolling the e-book content comprises:
scrolling the e-book content in a downward direction when the first user input is received at an upper region of the screen.

17. The method of claim 11, further comprising:
emphasizing a first portion of the screen while scrolling the e-book content in response to the first user input.

18. The method of claim 17, wherein the first portion of the screen coincides with one or more lines of text associated with the e-book content.

19. The method of claim 17, wherein emphasizing the first portion of the screen comprises:
obfuscating content displayed on the remainder of the screen.

20. A non-transitory computer-readable medium that stores instructions, that when executed by one or more processors, cause the one or more processors to perform operations that include:
displaying content pertaining to an e-book on a screen of a display assembly of the computing device;
detecting a first user interaction with a set of touch sensors provided with the display assembly; and
interpreting the first user interaction as a first user input; and
scrolling the e-book content displayed on the screen in response to the first user input.
